(19) United States
(12) Patent Application Publication
(10) Pub. No.: US 2012/0128272 A1
(43) Pub. Date: May 24, 2012

(54) Paper Bag With Detachable Card

(75) Inventor: Nadia Murgia, Nuoro (IT)

(73) Assignee: Francesco Guccini, Nuoro (IT)

(21) Appl. No.: 13/321,838

(22) PCT Filed: Apr. 1, 2010
(86) PCT No.: PCT/EP2010/054416

§ 371 Date: Feb. 7, 2012

(30) Foreign Application Priority Data
May 26, 2009 (EP) EP09161155.8
Apr. 1, 2010 (EP) PCT/EP2010/054416

(51) Int. Cl. B65D 30/22; B31B 1/00

(52) U.S. Cl. 383/40; 493/267

(57) ABSTRACT

The present invention is directed to a paper bag which contains at least one detachable card located in the internal folded upper part of the bag. The card can be used for example as a visiting card, a Christmas card, a S. Valentine card, an anniversary card or a discount coupon. The cards might have different shapes such as rectangular, a square, a star, a circle, a oval, or an image such as a tree, a heart or a Santa Claus.

The present invention is directed to a paper bag which contains at least one detachable card located in the internal folded upper part of the paper bag.

There are several types of paper bags which are used in very different conditions. In the case of shopping bags, the paper bag is used as an advertising tool, by printing the bag with the logo of the shop or of the goods sold by the shop. The bag very often contains also information relating to the address and telephone number of the shop. However, the bag is often thrown away after use and, in this way, the advertising effect of the bag is very limited in time.

Bags with detachable coupons are known from the prior art. U.S. Pat. No. 3,804,323 and FR 2 723 070 disclose a bag with detachable coupons. However, when the coupons are detached, the bag cannot be reused since the detachment of coupons destroys the bag. Furthermore the patents do not relate to shopping bags and the invention described in these patents cannot be applied to shopping bags.

GB 2 074 541 discloses a paper bag having an open top, closed bottom and a pair of opposed lateral edges and being formed by a procedure including the steps of folding a sheet of material so as to provide said edges, wherein the overlapping portion of the sheet extends beyond where it joins the overlapped portion and the extension is provided with a line of weakening whereby it may be separated from the bag. However, the bag according to this patent suffers from two drawbacks: the amount of paper to be used in its production is increased due to the overlapping portion, and the overlapping portion requires one or more points of glue to avoid that, when introducing an object into the bag, the overlapping portion becomes damaged or even destroyed.

The present invention intends to overcome these problems by inserting in the internal folded upper part of the shopping bag a detachable area which contains advertising information. The invention not only allows an improvement in the effectiveness of the advertising effect of the bag, but also allows the introduction of new forms of advertising, such as distribution of discounts, special promotions, Christmas cards, S. Valentine's cards, etc..

Furthermore, the present invention allows a saving since it renders unnecessary the separate printing of visiting cards, and it is environmentally friendly because it saves paper. In fact, the position of the detachable cards allows the use of the identical amount of paper that would be used for making the bag without cards.

Another important advantage is that the bag according to the invention remains aesthetically unchanged after detaching the card. This is especially important in the case of shopping bags, i.e. paper bags of high quality, with handles, whose cost is much higher than in the case of simple paper bags for cheap use.

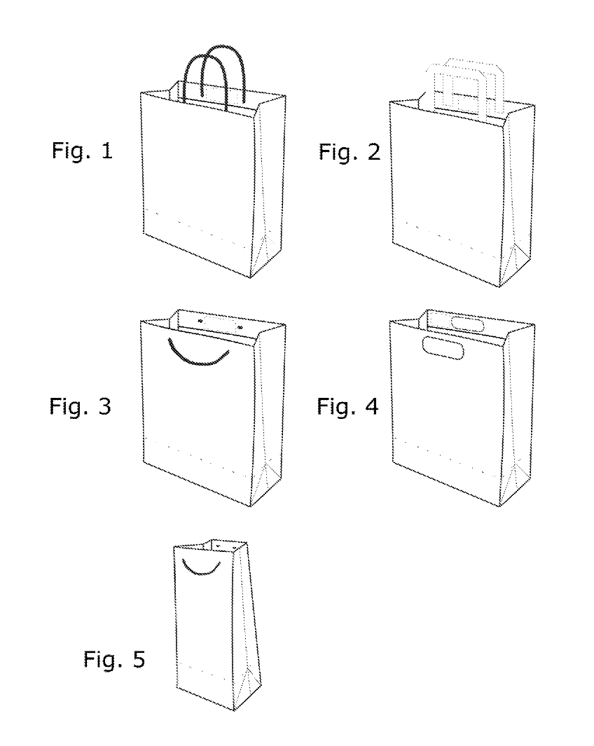

FIGS. 1-5 show different types of bags for use in the present invention.

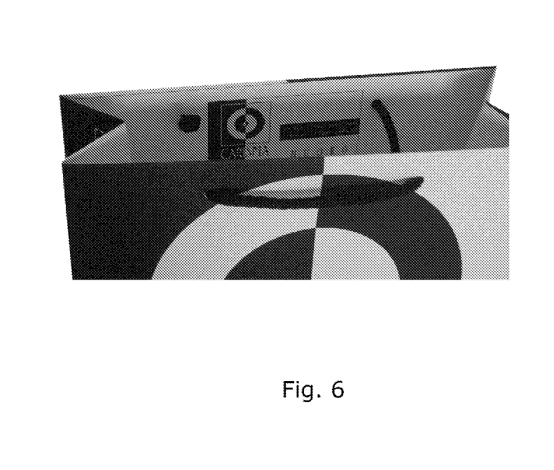

FIG. 6 shows a bag with the detachable card.

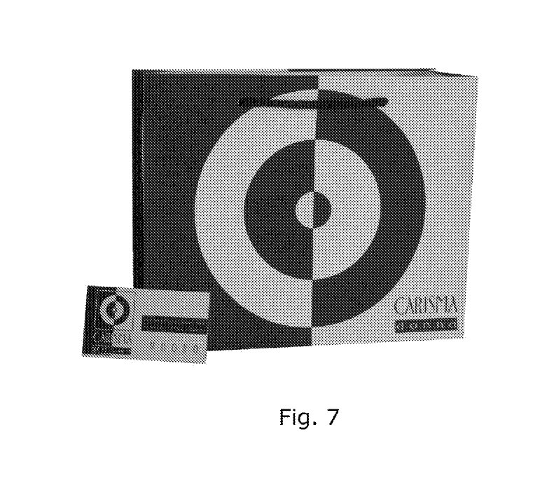

FIG. 7 shows the bag and the card detached from the bag.

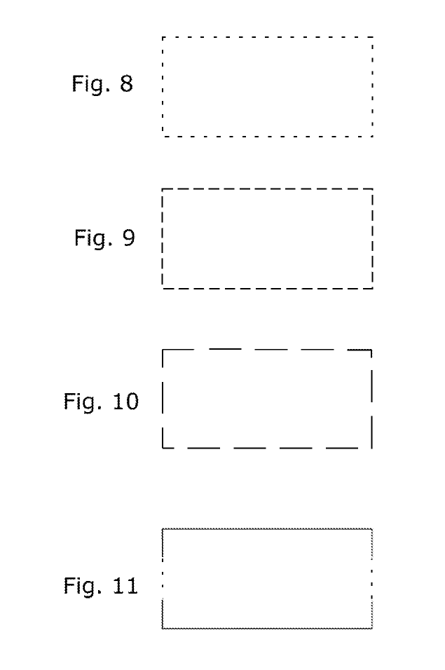

FIGS. 8-11 show various cutting sketches for the detachable card.

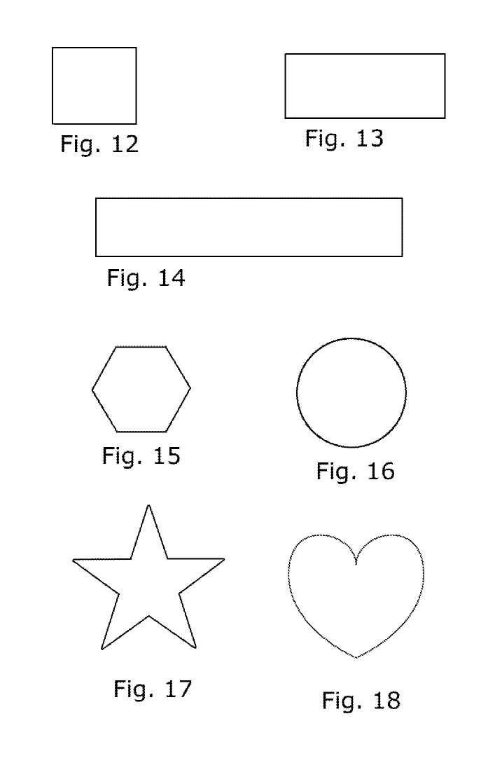

FIGS. 12-18 show different shapes for the detachable card.

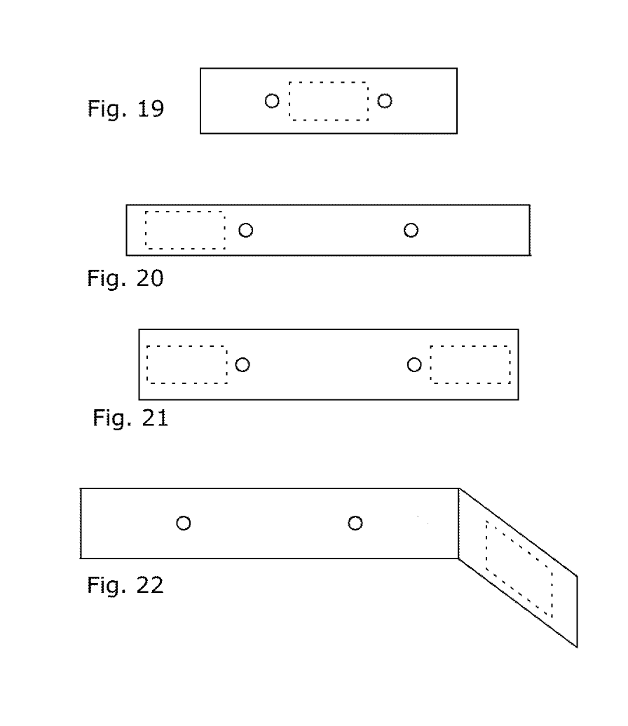

FIGS. 19-22 show different positions which can be used for the detachable card.

In a preferred embodiment of the invention, the paper bag according to the invention is a shopping bag and contains one or more detachable cards. The one or more detachable cards are located in the internal folded upper part of the paper bag, as illustrated in FIG. 6.

The size of the detachable area is not essential and can vary from very small to relatively large. It is important that the size does not create problems to the bag once removed. For example, when the card is inserted in the folded part of the bag in the vertical direction, its size is limited by the size of the folded part. In the horizontal direction, the size can be as long as allowed by the geometry of the bag. For example, the factor limiting the horizontal size of the card might be the distance between handles.

The thickness of the card depends on the thickness of the paper and on the possible presence of paperboard used as a reinforcing element.

In a preferred embodiment, the detachable area contains a visiting card of the shop. In another embodiment of the invention the detachable area contains a discount coupon. In a further embodiment of the invention the card is a festivity card, such as a S. Valentine card, a Christmas card, or an anniversary card.

The shape of the card can vary according to the specific purpose of the card. It is preferably rectangular when the card is the visiting card of the shop, but it can have the shape of a rectangle, a square, a star, a circle, a oval, or an image such as a heart for a S. Valentine bag, and a tree, a star or a Santa Claus for a Christmas bag.

The number of cards is at least one but can preferably vary from 2 to 8, according to the size of the card.

The paper bag according to the present invention is preferably produced according to conventional methods. For example, the bag can be produced by die-cutting with a conventional punch-cutter machine, where the card is punched on the paper bag. The card can be punched more strongly or weakly, i.e. the card can be detached easily or with more difficulty according to the specific needs. FIG. 4 shows different types of cutting sketches, which result in easier or more difficult detachment.

1. Paper bag containing one or more detachable card located in the internal folded upper part of the bag.

2. Paper bag according to claim 1, wherein the bag contains from 2 to 8 detachable cards.

3. Paper bag according to claim 1 wherein the detachable card is a visiting card, a Christmas card, a S. Valentine card, an anniversary card or a discount coupon.

4. Paper bag according to claim 1, wherein the card is a rectangle, a square, a star, a circle, a oval, or an image such as a tree, a heart or a Santa Claus.

5. Paper bag according to any one of claims 1-4 wherein the bag is a shopping bag.

6. A method for the production of the paper bag according to any one of claims 1-4, wherein the detachable card is obtained by die-cutting with a punch-cutter machine.
